(19) United States
(12) Patent Application Publication
(10) Pub. No.: US 2010/0264768 A1
(43) Pub. Date: Oct. 21, 2010

(54) PERMANENT MAGNET MACHINE WITH CONICAL STATOR

(75) Inventors: TIMOTHY J. ALFERMANN, NOBLESVILLE, IN (US); ARTHUR L. MCGREW, JR., INDIANAPOLIS, IN (US); AHMED M. EL-ANTABLY, CARMEL, IN (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/424,623

(22) Filed: Apr. 16, 2009

(51) Int. Cl. H02K 7/12

(52) U.S. Cl. 310/90

(57) ABSTRACT

A permanent magnet machine includes a stator, a rotor configured to coaxially rotate with respect to the stator and having a plurality of permanent magnets coupled thereto, and an air gap between the stator and the rotor having a magnitude that is continuously adjustable. The air gap may be adjusted to optimize torque, minimize back EMF, or optimize any characteristic of the permanent magnet machine during rotation.

### TECHNICAL FIELD

The present invention generally relates to permanent magnet machines, and more particularly relates to systems and methods for extending the range and torque of such machines.

### BACKGROUND

Permanent magnet machines are used in a variety of contexts, including hybrid cars, traditional automobiles, and the like. In general, typical permanent magnet machine includes a rotor having set of permanent magnets attached to or embedded within its exterior, and is configured to rotate axially with respect to a stator. The stator and rotor are generally concentric such that a fixed air gap is formed therebetween.

Currently known permanent magnet machines are unsatisfactory in a number of respects. For example, it is known that for any given rotational speed, the air gap necessary to achieve maximum torque is not a constant. Thus, traditional fixed air-gap machines typically provide optimum torque over a narrow range of speeds.

Furthermore, the back-EMF produced by a permanent magnet machine is a function of air-gap magnitude. During a fault condition, this back-EMF voltage can be significant enough to cause failure of the inverter switch. It would be desirable therefore to increase the air-gap under certain conditions to reduce back-EMF, thereby reducing the voltage requirements of the inverter switch.

Accordingly, it is desirable to provide improved permanent magnet machines with optimized torque characteristics. Additional desirable features and characteristics of the present invention will become apparent from the subsequent detailed description and the appended claims, taken in conjunction with the accompanying drawings and the foregoing technical field and background.

### BRIEF SUMMARY

A permanent magnet machine in accordance with one embodiment includes a stator, a rotor configured to coaxially rotate with respect to the stator and having a plurality of permanent magnets coupled thereto, and an air gap between the stator and the rotor having a magnitude that is continuously adjustable to optimize torque, reduce back-EMF, and the like.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a general axial cross-section view of a typical permanent magnet machine with surface mount magnets; and

FIGS. 2 and 3 are conceptual side views of a permanent magnet machine in accordance with one embodiment, illustrating a variable air gap.

### DETAILED DESCRIPTION

The following discussion generally relates to a permanent magnet machine with a tapered or conical stator (and matching rotor) that can be displaced axially to achieve a variable air gap. In that regard, the following detailed description is merely illustrative in nature and is not intended to limit the invention or the application and uses of the invention. Furthermore, there is no intention to be bound by any expressed or implied theory presented in the preceding technical field, background, brief summary or the following detailed description. For the purposes of conciseness, conventional techniques and principles related to magnetism, permanent magnet machines, motors, and the like need not and are not described herein.

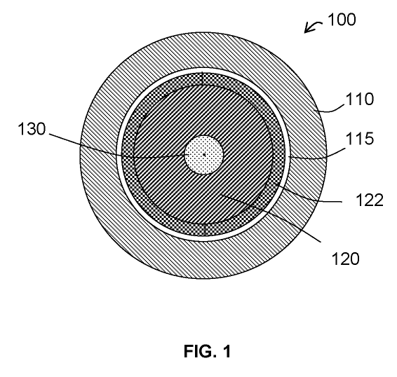

FIG. 1 depicts an axial cross-section of a typical permanent magnet machine 100 useful in describing the present invention. In general, a rotor 120 has a set of permanent magnets attached to its exterior and is configured to rotate axially with respect to a stator 110, thereby causing rotation of shaft 130. The stator 110 and rotor 120 are generally concentric such that an air gap 115 is formed therebetween.

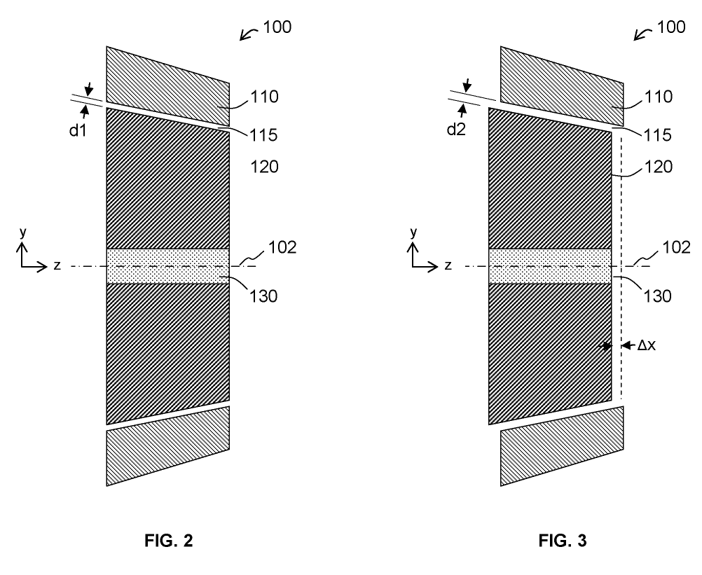

Referring to the lateral cross-sectional views shown in FIGS. 2 and 3, a permanent magnet machine (or simply “machine”) 100 in accordance with the present invention generally includes stator 110 and rotor 120, which is configured to coaxially rotate with respect to stator 110 and has a plurality of permanent magnets incorporated into the outer surface (not shown).

Air gap 115 is formed between the outer surface of rotor 120 and the inner surface of stator 110. In accordance with the present invention, the magnitude of air gap 115 is continuously adjustable, thereby allowing the operation of machine 100 to be optimized in accordance with any desired criteria.

Stator 110 and rotor 120 each have a generally tapered inner surface. That is, the diameter monotonically increases or decreases along the z-axis (the rotational axis 102). In the illustrated embodiment, the inner surface of stator 110 and the outer surface of rotor 120 are both generally conical and concentric. Thus, a consistent gap 115 having a magnitude d₁ is formed between the two surfaces.

As illustrated in FIG. 3, rotor 120 is configured to translate axially within stator 110 (Δx), thereby increasing and decreasing the air gap 115 (e.g., d₂>d₁). The ratio of axial translation to change in magnitude of the air gap Δd (namely, Δx/Δz) may be selected to achieve any desired resolution and range of air gap values. In one embodiment, for example, this ratio is between about 2.9 and 5.75. The cone shapes defining the rotor and stator may have any suitable base/height ratio—e.g., between about 0.25 and 3.0. The gap may be adjusted, for example, between about 0.7 mm and 4.0 mm.

As air gap 115 is continuously adjustable during rotation, it may be altered during rotation while monitoring a property of the permanent magnet machine, thereby allowing that property to be optimized. In one embodiment, the torque of machine 100 may be maximized while, for example, minimizing back EMF for any particular conditions. Such adjustments may be open loop (setting a particular air gap magnitude to achieve a corresponding empirically determined torque) or closed loop (providing a control system that continually monitors a characteristic and iteratively changes the air gap magnitude to optimize that characteristic).

The present inventors have found that the adjustable air gap system described above results in a permanent magnet machine with highly desirable characteristics. For example, by varying the air gap as a function of rotational speed, greater power output can be achieved within any given space constraints. At the same time, as the air gap is increased, the EMF voltage is reduced. During a fault condition, such EMF voltage can result in failure of any associated inverter switch. Reducing the EMF voltage therefore reduces the voltage requirements of the inverter switch.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. The foregoing detailed description provides those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A permanent magnet machine comprising:
a stator;
a rotor configured to coaxially rotate with respect to the stator and having a plurality of permanent magnets coupled thereto; and
an air gap between the stator and the rotor;
wherein the magnitude of the air gap is continuously adjustable.

2. The permanent magnet machine of claim 1, wherein the stator has a generally tapered inner surface, the rotor has a generally tapered outer surface, the air gap is defined by the inner surface of the stator and the outer surface of the rotor.

3. The permanent magnet machine of claim 2, wherein the inner surface of the stator and the outer surface of the rotor are both generally conical and concentric.

4. The permanent magnet machine of claim 3, wherein the rotor is configured to translate axially within the stator.

5. The permanent magnet machine of claim 4, wherein the ratio of axial translation to change in magnitude of the air gap is between about 2.9 and 5.75.

6. A stator for a permanent magnet machine comprising:
a plurality of surface-mount magnets defining an outer surface;
wherein the outer surface is generally tapered and configured to translate axially within a matching rotor.

7. The stator of claim 6, wherein the outer surface is conical.

8. The stator of claim 7, wherein the outer surface is defined by a cone having a ratio of base to height of between approximately 0.25 and 3.0.

9. A method for operating a permanent magnet machine, comprising:
providing a stator;
providing a rotor configured to coaxially rotate with respect to the stator and having a plurality of permanent magnets coupled thereto, wherein an air gap is defined between the stator and the rotor;
adjusting the position of the rotor with respect to the stator, during rotation, to adjust the magnitude of the air gap.

10. The method of claim 9, wherein the stator has a generally tapered inner surface, the rotor has a generally tapered outer surface, the air gap is defined by the inner surface of the stator and the outer surface of the rotor.

11. The method of claim 10, wherein the inner surface of the stator and the outer surface of the rotor are both generally conical and concentric.

12. The method of claim 11, wherein the rotor is configured to translate axially within the stator.

13. The method of claim 12, wherein the ratio of axial translation to change in magnitude of the air gap is between about 2.9 and 5.75.

14. The method of claim 1, further including continuously adjusting the air gap during rotation while monitoring a property of the permanent magnet machine to optimize that property.

15. The method of claim 14, wherein the property is torque.

16. The method of claim 1, further including continuously adjusting the air gap to minimize back EMF.
